(19) United States
(12) Patent Application Publication
(10) Pub. No.: US 2025/0356582 A1
(43) Pub. Date: Nov. 20, 2025

(54) TRAINING FOR MULTIMODAL CONDITIONAL 3D SHAPE GEOMETRY GENERATION

(71) Applicants: DISNEY ENTERPRISES, INC., Burbank, CA (US); ETH Zürich (Eidgenössische Technische Hochschule Zürich), Zürich (CH)

(72) Inventors: Christopher Andreas OTTO, Zürich (CH); Derek Edward BRADLEY, Zürich (CH); Sebastian Klaus WEISS, Zürich (CH); Gaspard ZOSS, Zürich (CH); Prashanth CHANDRAN, Zürich (CH)

(21) Appl. No.: 19/212,482

(22) Filed: May 19, 2025

Related U.S. Application Data
(60) Provisional application No. 63/649,280, filed on May 17, 2024.

(51) Int. Cl. G06T 17/00; G06N 20/00

(52) U.S. Cl. CPC G06T 17/00; G06N 20/00

(57) ABSTRACT

One embodiment of the present invention sets forth a technique for training a machine learning model on a geometry generation task. The technique includes generating, via execution of a diffusion model, a first set of training output corresponding to a first set of three-dimensional (3D) geometries based on a first set of conditioning inputs associated with a first conditioning mode, and training the diffusion model based on a first set of loss values associated with the first set of training output. The technique further includes generating, via execution of the diffusion model and a first adapter model, a second set of training output corresponding to a second set of 3D geometries based on a second set of conditioning inputs associated with a second conditioning mode, and training the first adapter model based on a second set of loss values associated with the second set of training output.

### CROSS-REFERENCE TO RELATED APPLICATIONS

This application claims the benefit of the U.S. Provisional Application titled “MULTI-MODAL CONDITIONAL 3D SHAPE GEOMETRY GENERATION,” filed on May 17, 2024, and having Ser. No. 63/649,280. The subject matter of this application is hereby incorporated herein by reference in its entirety.

### BACKGROUND

### Field of the Various Embodiments

Embodiments of the present disclosure relate generally machine learning and computer vision and, more specifically, to training for multimodal conditional three-dimensional (3D) shape geometry generation.

### Description of the Related Art

Realistic digital representations of faces, hands, bodies, and other recognizable objects are required for various computer graphics and computer vision applications. For example, digital representations of real-world deformable objects may be used in virtual scenes of film or television productions, video games, virtual worlds, and/or other environments and/or settings.

Traditionally, three-dimensional (3D) geometries of faces and/or other types of deformable objects have been generated via a time-consuming, iterative, and resource-intensive process involving digital sculpting with 3D modeling tools. For example, a user may spend days to weeks interacting with a 3D modeling tool to manually push, pull, smooth, grab, pinch, and/or otherwise manipulate a 3D geometry of a face. As the user interacts with the 3D geometry, the 3D modeling tool expends significant resources in updating a mesh and/or another 3D representation of the face based on sculpting input from the user, rendering the face to reflect the sculpting input, and/or outputting the rendered face to the user.

To simplify the task of modeling the 3D geometry of a face (or another type of deformable object), a parametric shape model can be used to express new faces as linear combinations of prototypical basis shapes from a dataset. However, a parametric shape model is typically unable to represent continuous, nonlinear deformations that are common to faces and other recognizable shapes. At the same time, linear combinations of input shapes generated by the parametric shape model can lead to unrealistic motion or physically impossible shapes. Consequently, the linear 3D morphable model is unable to represent all possible face shapes and is also capable of representing many non-face shapes.

More recently, advancements in machine learning and deep learning have led to the development of generative models that can create detailed 3D geometries and/or textures of faces and/or other shapes from text prompts. However, it can be difficult to achieve a desired visual and/or geometric characteristic through a textual description of a corresponding object. Other types of generative models are capable of generating images using sketches, image-based prompts, and/or types of input. However, techniques used by these types of generative models cannot be extended to the generation of 3D shapes in a straightforward manner.

As the foregoing illustrates, what is needed in the art are more effective techniques for generating 3D geometries of deformable objects.

### SUMMARY

One embodiment of the present invention sets forth a technique for training a machine learning model on a geometry generation task. The technique includes generating, via execution of a diffusion model, a first set of training output corresponding to a first set of three-dimensional (3D) geometries based on a first set of conditioning inputs associated with a first conditioning mode, and training the diffusion model based on a first set of loss values associated with the first set of training output. The technique further includes generating, via execution of the diffusion model and a first adapter model, a second set of training output corresponding to a second set of 3D geometries based on a second set of conditioning inputs associated with a second conditioning mode, and training the first adapter model based on a second set of loss values associated with the second set of training output.

One technical advantage of the disclosed techniques relative to the prior art is the ability to automatically generate a 3D geometry of a deformable object from a variety of user-defined conditioning inputs. Consequently, the disclosed techniques may reduce time and resource overhead associated with generating 3D geometries, compared with traditional techniques that involve users interacting with 3D modeling tools to manually sculpt 3D geometries of deformable objects. Additionally, because the generation of the 3D geometry can be guided using multiple types of conditioning inputs and/or control inputs, the 3D geometry may more accurately reflect a desired visual and/or geometric characteristic than 3D geometries that are generated based on text prompts by conventional machine learning models. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and generation engine of FIG. 1, according to various embodiments.

FIG. 3A illustrates how the generation engine of FIG. 2 generates different types of output geometry from different types of conditioning input, according to various embodiments.

FIG. 3B illustrates how an adapter model injects a conditioning input into a diffusion model, according to various embodiments.

FIG. 4A illustrates example output geometries generated from conditioning inputs associated with different conditioning modes and different guidance strengths, according to various embodiments.

FIG. 4B illustrates examples of sketch-based conditioning inputs, masked-based control inputs, and corresponding output geometry, according to various embodiments.

FIG. 5 is a flow diagram of method steps for training a machine learning model to perform multimodal conditional 3D shape geometry generation, according to various embodiments.

FIG. 6 is a flow diagram of method steps for performing multimodal conditional 3D shape geometry generation, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

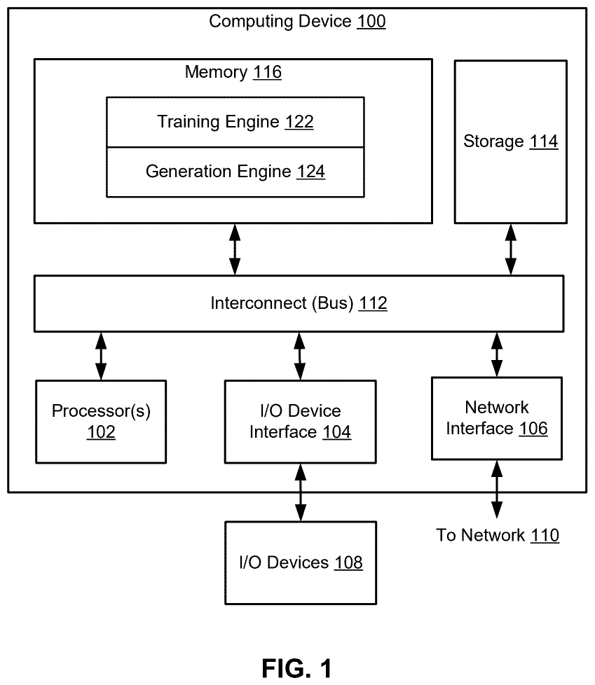

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an generation engine 124 that reside in memory 116.

It is noted that the computing device described herein is illustrative and that any other technically feasible configurations fall within the scope of the present disclosure. For example, multiple instances of training engine 122 and generation engine 124 could execute on a set of nodes in a distributed and/or cloud computing system to implement the functionality of computing device 100. In another example, training engine 122 and/or generation engine 124 could execute on various sets of hardware, types of devices, or environments to adapt training engine 122 and/or generation engine 124 to different use cases or applications. In a third example, training engine 122 and generation engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and generation engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and generation engine 124.

In one or more embodiments, training engine 122 and generation engine 124 are configured to train and execute a machine learning model to perform multimodal conditional three-dimensional (3D) shape geometry generation, in which a 3D geometry of a face (or another type of deformable object) is generated by a machine learning model based on input conditions associated with various conditioning modes corresponding to a different data modalities. For example, the machine learning model may generate the 3D geometry based on a sketch, a set of two-dimensional (2D) landmarks, a set of edges detected within an image, an image, text, parameters associated with a parametric shape model, and/or other types of input conditions. The machine learning model may include a diffusion model and/or one or more adapter models that generate a 2D position map corresponding to the 3D geometry by iteratively denoising a noise sample based on one or more conditions associated with one or more conditioning modes.

Training engine 122 trains the machine learning model over multiple training stages to adapt the machine learning model to the various conditioning modes. First, training engine 122 trains the diffusion model to generate 3D geometries based on base conditions associated with a base conditioning mode (e.g., parametric shape model parameters). Next, training engine 122 trains a different adapter model to inject additional conditions associated with an additional conditioning mode (e.g., sketch, landmarks, edges, image, text, etc.) into the diffusion model via cross-attention layers and/or another mechanism.

After training of the machine learning model is complete, generation engine 124 executes the trained machine learning model to generate new 3D geometries of deformable objects based on conditioning inputs from one or more conditioning modes and/or additional control inputs. For example, generation engine 124 may use the trained machine learning model to generate a position map corresponding to a 3D geometry of a deformable object based on parameters of a parametric shape model for the deformable object, an image of the deformable object, edges detected within the image, a sketch of the deformable object, 2D landmarks on the deformable object, and/or a text description of the deformable object. Generation engine 124 may also control the strength of a given conditioning input using a guidance strength associated with classifier-free guidance. Generation engine 124 may also, or instead, use a mask to specify regions within a spatial layout associated with the position map to which edits pertaining to a given conditioning input or set of conditioning inputs should be made. Training engine 122 and generation engine 124 are described in further detail below.

### Multimodal Conditional 3D Shape Geometry Generation

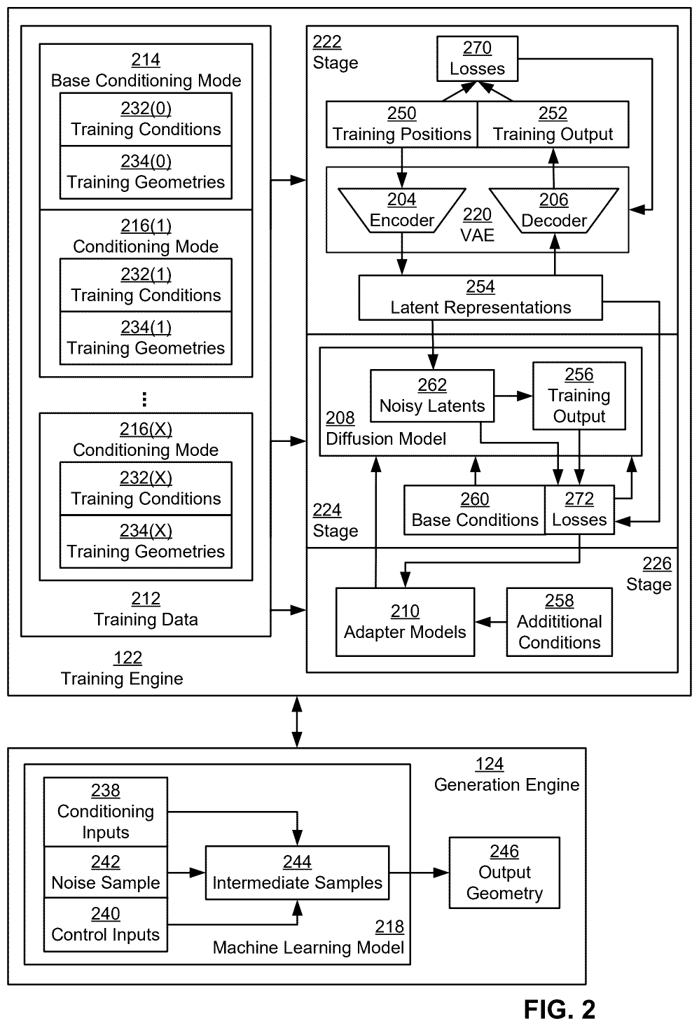

FIG. 2 is a more detailed illustration of training engine 122 and generation engine 124 of FIG. 1, according to various embodiments. As described above, training engine 122 and generation engine 124 include functionality to train and execute a machine learning model 218 to perform multimodal conditional 3D shape geometry generation. Each of these components is described in further detail below.

During multimodal conditional 3D shape geometry generation, machine learning model 218 is used to generate a 3D output geometry 246 for a face (or another type of deformable object) based on one or more conditioning inputs 238. Each conditioning input may be used to control one or more aspects of output geometry 246. For example, each conditioning input may be used to specify a different set of visual, geometric, and/or other attributes of the deformable object. Each conditioning input may also be incorporated into the generative process associated with machine learning model 218, so that output geometry 246 reflects the specified attributes.

Additionally, conditioning inputs 238 may be associated with various data modalities. One data modality may correspond to parameters of a parametric shape model such as (but not limited to) a 3D morphable model (3DMM), parametric face model, multilinear model, blendshape model, Faces Learned with an Articulated Model and Expressions (FLAME) model, and/or another type of parametric morphable model of a deformable object. A second data modality may correspond to a sketch depicting the deformable object. A third data modality may include an image of the deformable object. A fourth data modality may include a set of edges extracted from an image and/or another representation of the deformable object (e.g., as generated by an edge-detection technique). A fifth data modality may include a set of two-dimensional (2D) landmarks on the deformable object. A sixth data modality may include a text description of the deformable object.

In one or more embodiments, machine learning model 218 includes a diffusion model 208 that is associated with a forward diffusion process, in which Gaussian noise ϵₜ˜N (0, I) is added to a “clean” (e.g., without noise added) data sample x₀˜p_{data} (e.g., image, video frame, 3D geometry, etc.) from a corresponding data distribution over a number of diffusion time steps t∈[1, T]. The diffusion model also includes a learnable denoiser (e.g., a neural network) ϵ_{θ} that is trained to perform a denoising process that is the reverse of the forward diffusion process. Thus, the denoiser may iteratively remove noise from a pure noise sample 242 x_{T} over t time steps to generate t corresponding intermediate samples 244. A final intermediate sample may be denoised into denoised output that can be used as and/or incorporated into output geometry 246.

In some embodiments, diffusion model includes 208 corresponds to a latent diffusion model that operates in a compressed latent space instead of the space associated with output geometry 246. In the latent diffusion model, an encoder 204 ε produces a compressed latent representation z=ε(x) of a data sample from a corresponding data distribution, and the diffusion process is performed over z. A decoder 206 then reconstructs the latent features back into the space associated with the data distribution.

Training engine 122 trains different components of machine learning model 218 using training data 212 that includes different training conditions 232(0) and 232(1)-232(X) (each of which is referred to individually herein as training condition 232) paired with corresponding training geometries 234(0) and 234(1)-234(X) (each of which is referred to individually herein as training geometry 234). Additionally, pairs of training conditions 232 and training geometries 234 are grouped under different conditioning modes, which include a base conditioning mode 214 and a variable number of additional conditioning modes 216(1)-216(X) (each of which is referred to individually herein as conditioning mode 216).

In one or more embodiments, each of base conditioning mode 214 and the additional conditioning modes 216 corresponds to a different data modality associated with conditioning inputs 238. Thus, training conditions 232 associated with a given conditioning mode (e.g., base conditioning mode 214 or another conditioning mode 216) include various conditioning inputs 238 in the corresponding data modality. Each training condition 232 is paired with a corresponding training geometry 234 that includes attributes described, defined, and/or depicted by that training condition 232.

In some embodiments, base conditioning mode 214 corresponds to a data modality that is associated with a large number of pairs of training conditions 232(0) and training geometries 234(0). For example, training conditions 232(0) in base conditioning mode 214 may include different sets of parameters associated with a parametric shape model. Because these parameters can be fit to a given training geometry 234, training conditions 232(0) can be generated for as many training geometries 234 as desired (or available) in training data 212.

Other conditioning modes 216 may be associated with fewer pairs of training conditions 232 and training geometries 234. For example, training data 212 associated with an image-based conditioning mode 216 may include a certain number of training geometries 234 for a set of deformable objects and a corresponding number of photographs of the same deformable objects. Training data 212 associated with an edge-based conditioning mode 216 may include the same training geometries 234 and edges extracted from the photographs (e.g., using an edge detection technique). Training data 212 associated with a landmark-based conditioning mode 216 may include the same training geometries 234 and 2D landmarks extracted from the photographs (e.g., using a landmark detection technique). Training data 212 associated with a sketch-based conditioning mode 216 may include a set of training geometries 234 and a corresponding number of sketches that rendered on top of texture maps associated with these training geometries 234. Training data 212 associated with a text-based conditioning mode 216 may include a set of training geometries 234 and a corresponding set of text descriptions (e.g., as generated by one or more users, a multimodal language model, etc.).

In one or more embodiments, training engine 122 (or another component) generates training geometries 234 in training data 212 using a dataset of scanned 3D geometries of faces (or other types of deformable objects). The dataset may include a certain number of facial identities, where each identity is associated with scanned 3D geometries of a number of different facial expressions. Each scanned 3D geometry may be associated with a fixed mesh layout from which a template mesh is subtracted to obtain a delta representation. The delta representation may be transformed into a 2D position map in UV space for processing by one or more 2D convolutional neural networks in machine learning model 218. The 2D position map stores the x, y, and z displacements of a corresponding scanned 3D geometry from the template mesh at each pixel. Each 2D position map may be added as a representation of a corresponding training geometry 234 to training data 212.

The scanned 3D geometries may also be augmented to generate additional training geometries 234 in training data 212. For example, training geometries 234 associated with synthetic identities may be generated by interpolating between meshes associated with different identities and the same expression and/or by exchanging portions of meshes associated with the same facial part (e.g., nose, chin, eyes, mouth, cheeks, etc.) and different identities. These additional identities may improve the generalization of machine learning model 218 to novel identities.

After training data 212 is populated with training geometries 234 that include and/or are derived from scanned 3D geometries and augmentations of the scanned 3D geometries, training engine 122 may generate and/or determine one or more training conditions 232 for each training geometry 234. For example, training engine 122 may generate training conditions 232(0) associated with base conditioning mode 214 for some or all training geometries 234 in training data 212 by fitting parameters of a parametric shape model to mesh representations of training geometries 234. Training engine 122 may also generate training conditions 232(1)-232(X) associated with additional conditioning modes 216(1)-216(X) based on the availability of corresponding data for various training geometries 234, as described above.

Training engine 122 may also train different portions of machine learning model 218 over a number of stages 222, 224, and 226. During a first stage, training engine 122 trains encoder 204 and decoder 206 to learn latent representations 254 of training geometries 234. For example, encoder 204 and decoder 206 may be included in a variational autoencoder (VAE) 220 that downsamples a 2D position map by a certain factor into a corresponding 2D latent space that preserves the spatial layout of the 2D position map.

More specifically, training engine 122 may input training positions 250 from 2D position maps in training geometries 234 into encoder 204. Training engine 122 may use encoder 204 to generate latent representations 254 of the inputted position maps. Training engine 122 may use decoder 206 to decode latent representations 254 into training output 252 in the space of the 2D position maps. Training engine 122 may compute one or more losses 270 between training positions 250 and training output 252. Training engine 122 may also use a training technique (e.g., gradient descent and backpropagation) to update parameters of encoder 204 and decoder 206 in a way that reduces losses 270.

In one or more embodiments, losses 270 include the following representation:

$${ℒ}_{VAE} = {ℒ}_{rec} + {ℒ}_{GAN} + {ℒ}_{reg} \qquad ( 1 )$$

In the above equation, [symbol] _{rec} includes of a pixel-wise L1 loss and a learned perceptual image patch similarity (LPIPS) perceptual loss, which are used to compare training positions 250 in the input position maps to training output 252 corresponding to reconstructions of the position maps through VAE 220. [symbol] _{GAN} evaluates position maps storing input training positions 250 x and training output 252 [symbol] (ε(x)) with a patch-based discriminator. [symbol] _{reg} includes a codebook loss that acts as a latent space regularizer.

Next, training engine 122 performs stage 224 to train diffusion model 208 to generate denoised output corresponding to latent representations 254 z=ε(x) based on base conditions 260 corresponding to training conditions 232(0) associated with base conditioning mode 214. During stage 224, training engine 122 may use a forward diffusion process that converts latent representations 254 into noise following a fixed noise schedule of T uniformly sampled time steps. Within this forward diffusion process, noisy latents 262 zₜ at arbitrary time steps t may be directly sampled using the following:

$${z}_{t} ( {z}_{0} , ϵ ) = \sqrt{{\overline{α}}_{t}} {z}_{0} + \sqrt{1 - {\overline{α}}_{t}} ϵϵ ∼ 𝒩 ( 0 , I ) , \qquad ( 2 )$$

where 1−α̅ₜ describes the variance of the noise and

$${\overline{α}}_{t} := {\prod }_{s = 1}^{t} {α}_{s}$$

according to a fixed noise schedule.

Training engine 122 may use diffusion model 208 to generate training output 256 corresponding to predictions of noise added to noisy latents 262. Training engine 122 then trains diffusion model 208 using losses 272 computed based on the actual noise e added to noisy latents 262 and training output 256:

$${ℒ}_{LDM} = {𝔼}_{{z}_{0} , {c}_{0} , t , ϵ ∼ 𝒩 ( 0 , I )} [ {‖ ϵ - {ϵ}_{θ} ( {z}_{t} , {c}_{0} , t ) ‖}_{2}^{2} ] , \qquad ( 3 )$$

where z₀ is a clean latent representation (e.g., from latent representations 254), ϵ_{θ}(zₜ, c₀, t) is a denoiser (e.g., a U-Net), and c₀=Σ_{ϕ}(y) is a set of base conditions 260 (e.g., parameters of a parametric shape model associated with the clean latent representation) that are injected via cross-attention layers in the denoiser. Alternatively, training engine 122 may train diffusion model 208 using other losses associated with latent representations 254, such as a loss that is computed between predictions of latent representations 254 generated by diffusion model 208 from noisy latents 262 and the corresponding latent representations 254.

After stage 224 is complete, diffusion model 208 may be used to generate latent representations 254 of 2D position maps from a learned distribution. For example, diffusion model 208 may be used to iteratively denoise a latent noise sample 242 z_{T}˜ [symbol] (0, I) into less noisy intermediate samples 244 until a clean latent sample z₀ is produced. The clean latent sample may then be decoded by decoder 206 into a corresponding position map that reflects any base conditions 260 inputted into diffusion model 208.

Training engine 122 then performs stage 226 to generate one or more adapter models 210 that can be used to adapt the generative process of diffusion model 208 to additional conditioning modes 216. For example, training engine 122 may use stage 226 to train a separate adapter model for each conditioning mode 216 while keeping diffusion model 208 frozen.

In one or more embodiments, each adapter model includes an additional set of cross-attention layers that is used to inject conditioning inputs 238 associated with a corresponding conditioning mode 216 into diffusion model 208. The output of the additional cross-attention layers is added to the output of existing cross-attention layers in diffusion model 208:

$$Z = Attention ( Q , K , V ) + {Attention}^{′} ) Q , {K}_{m}^{′} , {V}_{m}^{′} ) , \qquad ( 4 )$$

where Q represents intermediate U-Net query features, K and V are keys and values for base conditions 260 c₀, and K′ₘ, V′ₘ are keys and values for the newly injected conditioning mode 216 cₘ:

$$\begin{matrix}K = {c}_{0} \cdot {c}_{0} \cdot {W}_{k} , V = {c}_{0} \cdot {W}_{v} \\ {K}_{m}^{′} = {c}_{m} \cdot {W}_{k , m}^{′} , {V}_{m}^{′} = {c}_{m} \cdot {W}_{v , m}^{′}\end{matrix} \qquad ( 5 )$$

In Equation 5, W′_{k,m} and W′_{v,m} represent newly added weights for the cross-attention layers that are updated during training.

During stage 226, training engine 122 uses an adapter model to input representations of additional conditions 258 associated with a given conditioning mode 216 into diffusion model 208. Training engine 122 also uses diffusion model 208 to generate training output 256 from noisy latents 262 associated with training geometries 234 that are paired with these additional conditions 258. Training engine 122 computes losses 272 based on training output 256, noisy latents 262, and/or latent representations 254 and updates the cross-attention layers in the adapter model based on the computed losses 272.

While the operation of training engine 122 has been described as occurring over three stages 222, 224, and 226, it will be appreciated that training engine 122 may use different numbers and/or orderings of stages to train various parts of machine learning model. For example, training engine 122 may omit stage 222 if machine learning model 218 does not include VAE 220 (e.g., if machine learning model 218 is not a latent diffusion model). In another example, training engine 122 may repeat stage 226 to generate additional adapter models 210 that support new conditioning modes 216 associated with generation of 3D geometries by machine learning model 218.

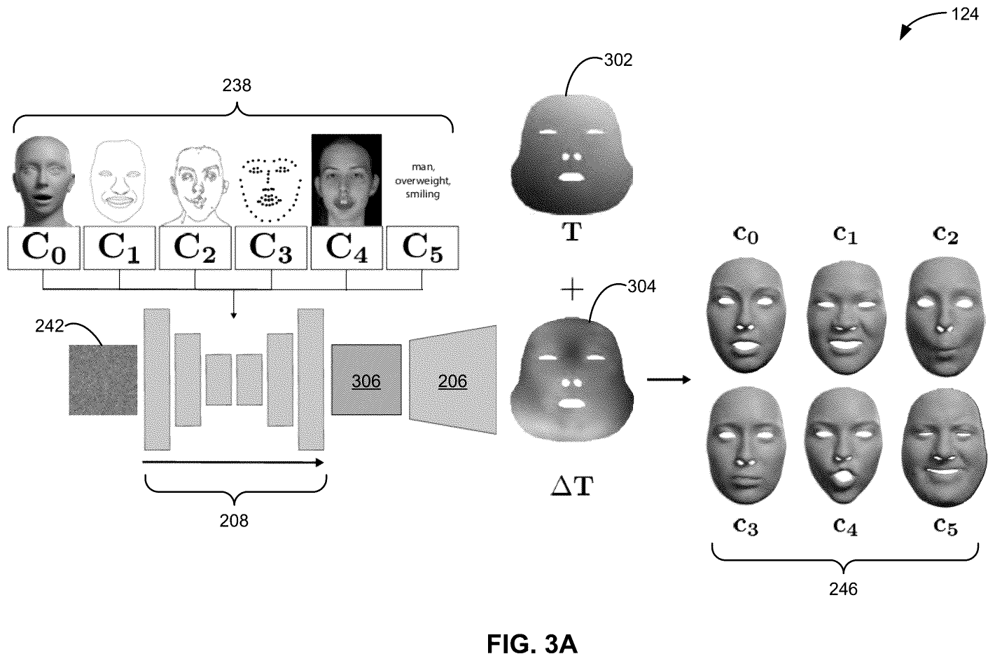

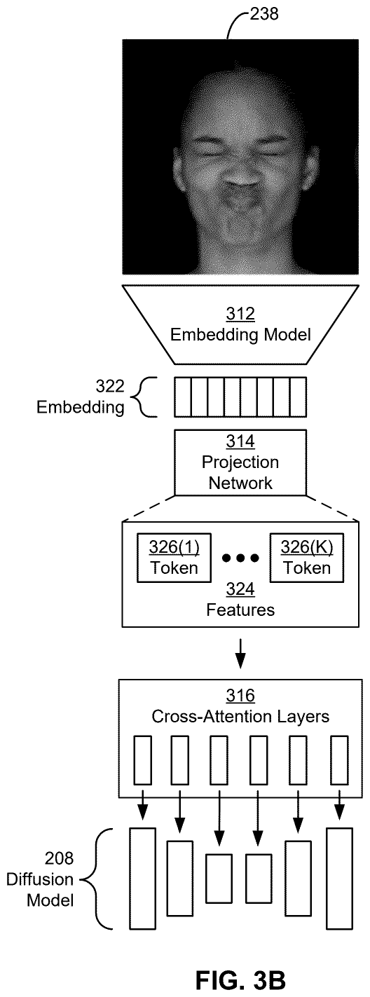

After training of machine learning model 218 over stages 222, 224, and/or 226 is complete, generation engine 124 uses the trained machine learning model 218 to generate a new output geometry 246 based on various types and/or combinations of conditioning inputs 238, as described in further detail below with respect to FIG. 3A. During generation of output geometry 246 based on conditioning inputs 238 associated with one or more conditioning modes 216, generation engine 124 may use cross-attention layers and/or other components of the corresponding adapter models 210 to inject these conditioning inputs 238 into diffusion model 208, as described in further detail below with respect to FIG. 3B.

FIG. 3A illustrates how generation engine 124 of FIG. 2 generates different types of output geometry 246 from different types of conditioning inputs 238, according to various embodiments. As shown in FIG. 3A, six different types of conditioning inputs 238 are represented by C₀ to C₅. The conditioning input represented by C₀ may correspond to parameters of a parametric shape model, the conditioning mode represented by C₁ may correspond to a sketch, the conditioning mode represented by C₂ may correspond to a set of edges, the conditioning mode represented by C₃ may correspond to 2D landmarks, the conditioning mode represented by C₄ may correspond to an image, and the conditioning mode represented by C₅ may correspond to a text description.

Each conditioning input is used to generate a corresponding output geometry 246 that is represented by c₀ toc c₅. More specifically, the parameters associated with the conditioning input represented by Cᵢ, where i=[0,1,2,3,4,5], may be used to generate a corresponding output geometry 246 that is represented by cᵢ.

To generate a given output geometry 246, generation engine 124 generates noise sample 242 based on a seed and/or by sampling from a Gaussian distribution. Generation engine 124 uses diffusion model 208 iteratively denoise noise sample 242 into a corresponding latent sample 306. When conditioning inputs 238 include a condition that is associated with base conditioning mode 214, generation engine 124 may use cross-attention layers in diffusion model 208 to generate a conditioned representation that is used to denoise noise sample 242. When conditioning inputs 238 include a condition that is associated with a different conditioning mode 216, generation engine 124 may use cross-attention layers from an adapter model associated with that conditioning mode 216 to inject the condition into diffusion model 208 and generate a corresponding conditioned representation that is used to denoise noise sample 242.

After denoising of noise sample 242 into latent sample 306 is complete, generation engine 124 uses decoder to decode latent sample 306 into a position map 304 ΔT that stores 3D displacements in each pixel. These 3D displacements are combined with 3D positions stored in a position map 302 T for a template mesh with a fixed layout to produce vertex locations for a corresponding output geometry 246.

In some embodiments, a given output geometry 246 may be generated with more or less than one conditioning input. For example, generation engine 124 may use machine learning model 218 to generate output geometry 246 unconditionally (e.g., in the absence of any conditioning input) by setting the conditioning input associated with cross-attention layers in diffusion model 208 to a null embedding and omitting the use of additional cross-attention layers with diffusion model 208. The conditioning input associated with cross-attention layers in diffusion model 208 may also be set to the null embedding when conditioning inputs 238 are associated with one or more conditioning modes 216 and not base conditioning mode 214. When conditioning inputs 238 associated with multiple conditioning modes are used, generation engine 124 may use diffusion model 208 to denoise noise sample 242 based on the sum (or another aggregation of) the outputs of the corresponding cross-attention layers.

FIG. 3B illustrates how an adapter model (e.g., adapter models 210 of FIG. 2) injects a conditioning input into a diffusion model, according to various embodiments. As shown in FIG. 3B, conditioning inputs 238 associated with a given conditioning mode 216 are inputted into an embedding model 312 to produce a corresponding embedding 322. For example, embedding model 312 may include a Contrastive Language-Image Pre-Training (CLIP) model and/or another type of multimodal embedding model that generates embedding 322 in a shared embedding space that is associated with multiple data modalities. This embedding 322 acts as a conditioning representation that is used to control the operation of diffusion model 208.

A projection network 314 projects embedding 322 onto a set of features 324 that include multiple tokens 326(1)-326(K) (each of which is referred to individually herein as token 326). For example, projection network 314 may include a linear layer and layer normalization that convert embedding 322 into a certain number of tokens 326 to facilitate the computation of attention using the conditioning representation.

Cross-attention layers 316 associated with conditioning mode 216 are used to compute keys and values using features 324 and combine the keys and values with queries from diffusion model 208. The resulting output of cross-attention layers 316 is added to the output of existing cross-attention layers in diffusion model 208 and used to generate a conditioned representation that controls the denoising process performed using diffusion model 208.

Returning to the discussion of FIG. 2, in some embodiments, generation engine 124 generates a temporally stable sequence of output geometries corresponding to a dynamic facial performance using conditioning inputs 238 based on a corresponding sequence of video frames (or other depictions of the facial performance). For example, generation engine 124 may generate sketches, landmarks, edges, parametric shape model parameters, and/or other representations of the facial performance from a video. Generation engine 124 may temporally smooth embeddings of the representations generated by embedding model 312 before using the embeddings as conditioning representations for the corresponding output geometries. Generation engine 124 may also, or instead, use the same noise seed to generate noise samples that are denoised by diffusion model 208 based on the conditioning representations.

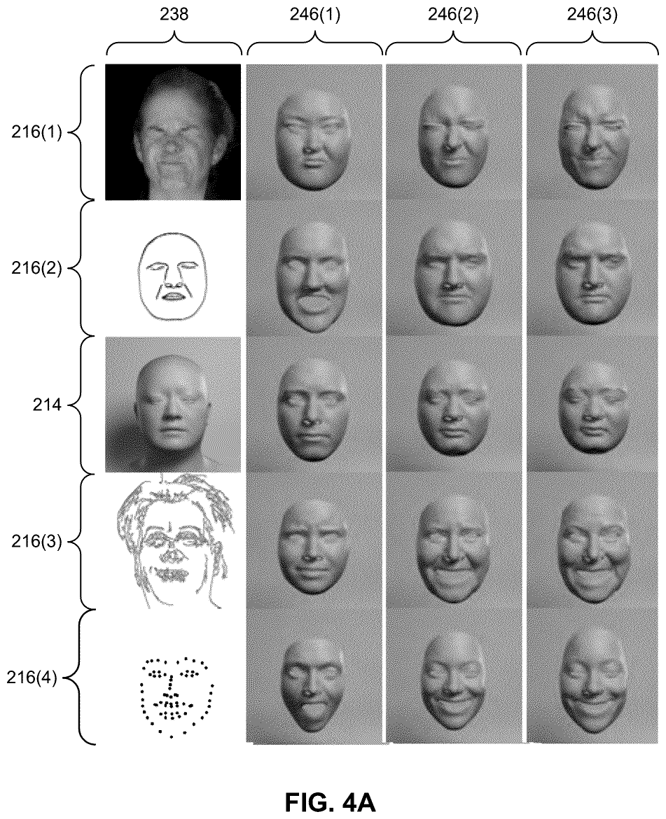

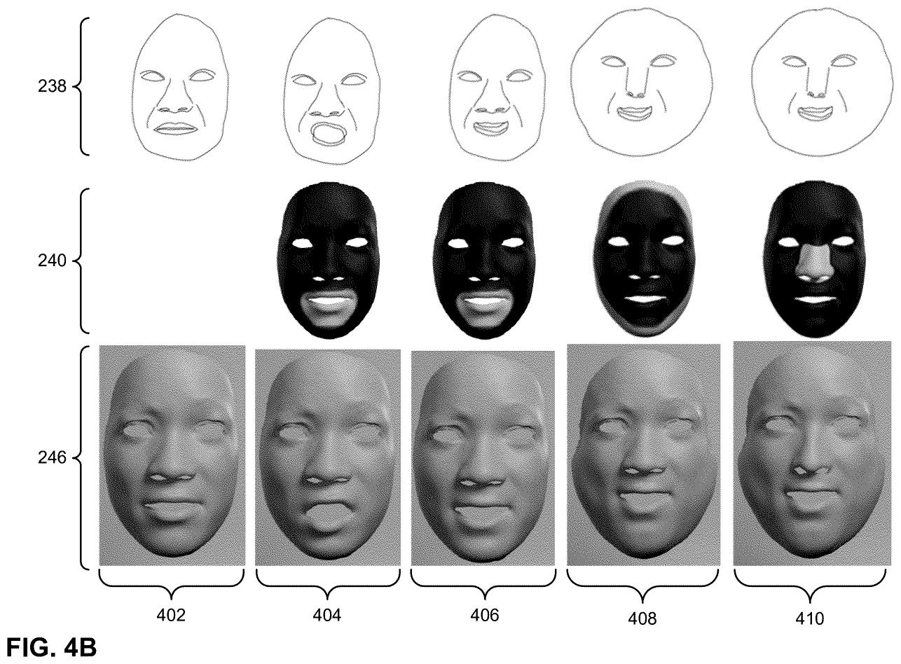

Further, generation engine 124 may use one or more control inputs 240 to further guide the generation of output geometry 246 by machine learning model 218. These control inputs 240 may include guidance strengths associated with different conditioning modes, as described in further detail below with respect to FIG. 4A. These control inputs 240 may also, or instead, include masks that can be used to selectively edit regions of output geometry 246, as described in further detail below with respect to FIG. 4B.

FIG. 4A illustrates example output geometries 246(1), 246(2), and 246(3) generated from conditioning inputs 238 associated with different conditioning modes and different guidance strengths, according to various embodiments. As shown in FIG. 4A, conditioning inputs 238 include an image associated with a first conditioning mode 216(1), a sketch associated with a second conditioning mode 216(2), a set of parameters associated with base conditioning mode 214, a set of edges associated with a third conditioning mode 216(3), and a set of landmarks associated with a fourth conditioning mode 216 (4).

Output geometries 246(1), 246(2), and 246(3) generated from conditioning inputs 238 are associated with three different guidance strengths. More specifically, a hyperparameter w representing guidance strength may be specified in control inputs 240 and used with classifier-free guidance to control the extent to which output geometry 246 is affected by a corresponding set of conditioning inputs 238:

$${\hat{ϵ}}_{θ} ( {z}_{t} , {c}_{0} , {c}_{m} , t ) = w {ϵ}_{θ} ( {z}_{t} , {c}_{0} , {c}_{m} , t ) + ( 1 - w ) {ϵ}_{θ} ( {z}_{t} , t ) \qquad ( 6 )$$

In the above equation, ϵ_{θ}(zₜ, c₀, cₘ, t) represents conditional generation using diffusion model 208 and ϵ_{θ}(zₜ, t) represents unconditional generation using diffusion model 208.

Each output geometry 246(1) is generated using a conditioning strength of w=0, which corresponds to unconditional generation. Consequently, the generation of each output geometry 246(1) is not affected by the corresponding conditioning input. Each output geometry 246(2) is generated using a conditioning strength of w=1, which reflects a partial effect from the corresponding conditioning input. Each output geometry 246(3) is generated using a conditioning strength of w=3 and reflects a stronger effect from the corresponding conditioning input. For example, the expression of output geometry 246(3) generated from the image associated with conditioning mode 216(1) includes stronger wrinkles and a closer match to the face depicted in the image than the other two output geometries 246(1) and 246(2) generated from the same image.

FIG. 4B illustrates examples 402, 404, 406, 408, and 410 of sketch-based conditioning inputs 238, masked-based control inputs 240, and corresponding output geometry 246, according to various embodiments. In example 402, output geometry 246 is generated from conditioning inputs 238 that include a sketch of a first face and no control input. In example 404, output geometry 246 is generated from conditioning inputs 238 that include a sketch of a second face and control inputs 240 that include a masked area over a mouth region of output geometry 246 from example 402. The sketch and masked area are used to incorporate the open mouth in the second face into output geometry 246 while keeping other regions of the output geometry 246 of example 402 unmodified.

In example 406, output geometry 246 is generated from conditioning inputs 238 that include a sketch of a third face and control inputs 240 that include the same masked area over a mouth region of output geometry 246 from example 402. The sketch and masked area are used to incorporate the smiling mouth in the third face into output geometry 246 while keeping other regions of the output geometry 246 of example 402 unmodified.

In example 408, output geometry 246 is generated from conditioning inputs 238 that include a sketch of a fourth face and control inputs 240 that include a masked area over the periphery of output geometry 246 from example 402. The sketch and masked area are used to incorporate the wideness of the fourth face into output geometry 246 while keeping other regions of the output geometry 246 of example 402 unmodified.

In example 410, output geometry 246 is generated from conditioning inputs 238 that include a sketch of the fourth face and control inputs 240 that include a masked area over a nose region of output geometry 246 from example 402. The sketch and masked area are used to incorporate the narrow nose of the fourth face into output geometry 246 while keeping other regions of the output geometry 246 of example 402 unmodified.

In some embodiments, masked control inputs 240 are specified by masking regions in the latent position map associated with latent representations 254, which preserves the spatial layout of the position map used to generate output geometry 246. Masked regions specified in control inputs 240 can then be denoised by diffusion model 208 based on conditioning inputs 238 to selectively edit specific regions of output geometry 246. For example, during each denoising step that denoises a noisy latent zt into a less noisy latent zₜ₋₁, known (e.g., unmasked) regions of the less noisy latent may be generated by adding noise to a given output geometry 246 (or another geometry) using Equation 2, and diffusion model 208 may be used to predict the unknown (e.g., masked) regions of the less noisy latent from the noisy latent. The known regions and predicted unknown regions are then combined into a less noisy latent, which is used as the noisy latent in the next denoising step.

The denoising process described above may smoothly interpolate portions of output geometry 246 in the vicinity of masks with sharp boundaries. Additionally, a sequence of masked control inputs 240 and conditioning inputs 238 may be used with machine learning model 218 to progressively edit output geometry 246 (e.g., by modifying one region at a time).

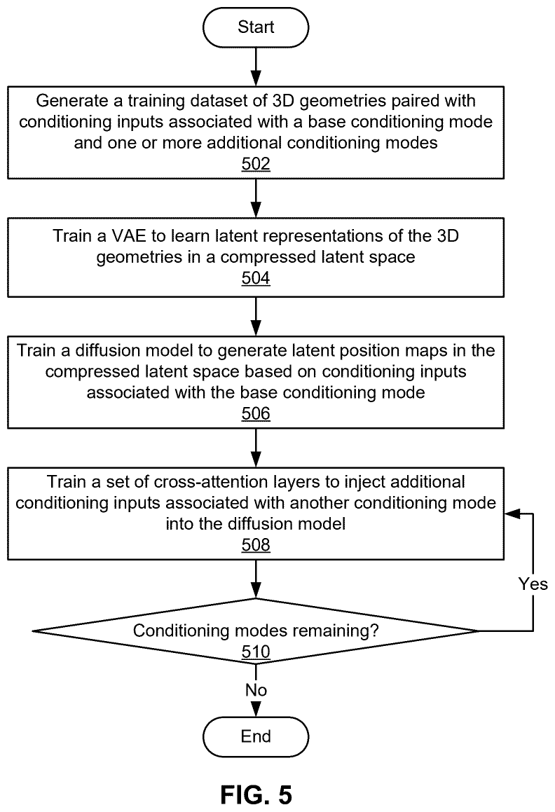

FIG. 5 is a flow diagram of method steps for training a machine learning model to perform multimodal conditional 3D shape geometry generation, according to various embodiments. Although the method steps are described in conjunction with the systems of FIGS. 1-2, persons skilled in the art will understand that any system configured to perform some or all of the method steps in any order falls within the scope of the present disclosure.

As shown, in step 502, training engine 122 generates a training dataset of 3D geometries paired with conditioning inputs associated with a base conditioning mode and one or more additional conditioning modes. For example, training engine 122 may populate the training dataset with scanned 3D geometries and additional 3D geometries that are generated by augmenting the scanned 3D geometries. Training engine 122 may generate conditioning inputs associated with a base conditioning mode corresponding to parameters of a parametric shape model by fitting different sets of parameters to different 3D geometries in the training dataset. Training engine 122 may also generate conditioning inputs associated with additional conditioning modes based on available data for the corresponding 3D geometries.

In step 504, training engine 122 trains a VAE to learn latent representations of the 3D geometries in a compressed latent space. For example, training engine 122 may compute a reconstruction loss, perceptual loss, adversarial loss, codebook loss, divergence loss, and/or another type of loss from latent representations generated by an encoder in the VAE from the 3D geometries and/or reconstructions of the 3D geometries generated by a decoder in the VAE from the latent representations. Training engine 122 may also update parameters of the VAE in a way that reduces the loss(es).

In step 506, training engine 122 trains a diffusion model to generate latent position maps in the compressed latent space based on conditioning inputs associated with the base conditioning mode. For example, training engine 122 may use the diffusion model to generate noise predictions, denoised samples, and/or other training output associated with noisy latents corresponding to latent representations outputted by the encoder of the trained VAE from the 3D geometries. Training engine 122 may compute one or more loss values based on the training output and corresponding “ground truth” values derived from the latent representations. Training engine 122 may the update parameters of the diffusion model in a way that reduces the loss(es).

In step 508, training engine 122 trains a set of cross-attention layers to inject additional conditioning inputs associated with another conditioning mode into the diffusion model. For example, training engine 122 may use an adapter model to generate, from a given conditioning input, a set of tokens that is processed by the cross-attention layers to generate keys and values. Training engine 122 may use the cross-attention layers to combine the keys and values with features from the diffusion model into a conditioned representation. Training engine 122 may also compute one or more loss values using output generated by the diffusion model from the conditioned representation (e.g., using the same loss function used to train the diffusion model in step 506) and update parameters of the cross-attention layers in a way that reduces the loss(es).

In step 510, training engine 122 determines whether additional conditioning modes remain. For example, training engine 122 may determine that one or more conditioning modes remain if a separate set of cross-attention layers has not been trained for each conditioning mode that is not the base conditioning mode. While training engine 122 determines in step 510 that conditioning modes are remaining, training engine 122 repeats step 508 to train an additional set of cross-attention layers for each remaining conditioning mode. Once training engine 122 determines in step 510 that no conditioning modes are remaining, training of the machine learning model is complete.

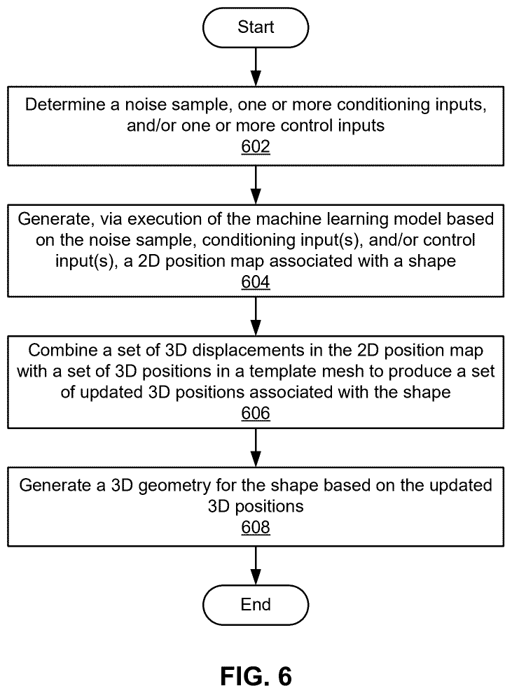

FIG. 6 is a flow diagram of method steps for performing multimodal conditional 3D shape geometry generation, according to various embodiments. Although the method steps are described in conjunction with the systems of FIGS. 1-2, persons skilled in the art will understand that any system configured to perform some or all of the method steps in any order falls within the scope of the present disclosure.

As shown, in step 602, generation engine 124 determines a noise sample, one or more conditioning inputs, and/or one or more control inputs. For example, generation engine 124 may generate the noise sample by sampling from a Gaussian distribution and/or based on a noise seed. Generation engine 124 may also, or instead, obtain the conditioning input(s) as an image, sketch, set of landmarks, set of edges, set of parameters in a parametric shape model, text description, and/or another type of data. Generation engine 124 may also, or instead, obtain the conditioning input(s) as a guidance strength and/or a mask associated with a 2D position map.

In step 604, generation engine 124 generates, via execution of the machine learning model based on the noise sample, conditioning input(s), and/or control input(s), a 2D position map associated with a shape. Continuing with the above example, generation engine 124 may use a diffusion model to iteratively denoise the noise sample into the 2D position map and/or a latent representation of the 2D position map. During denoising of the noise sample, generation engine 124 may inject the conditioning input(s) into the diffusion model via one or more sets of cross-attention layers. Generation engine 124 may also, or instead, use the guidance strength with classifier-free guidance to control the extent to which the noise sample is denoised based on the conditioning input(s). Generation engine 124 may also, or instead, use the mask to selectively denoise portions of the noise sample using the diffusion model. When the noise sample is denoised into a latent representation of the 2D position map, generation engine 124 may use a decoder to decode the latent representation into the 2D position map.

In step 606, generation engine 124 combines a set of 3D displacements in the 2D position map with a set of 3D positions in a template mesh to produce a set of updated 3D positions associated with the shape. For example, generation engine 124 may add each 3D displacement in the 2D position map to a corresponding 3D position in another position map associated with the template mesh to produce an updated 3D position at the same pixel location.

In step 608, generation engine 124 generates a 3D geometry for the shape based on the updated 3D positions. For example, generation engine 124 may populate vertices in a mesh with a fixed layout that corresponds to the spatial layout of the 2D position map with the updated 3D positions.

In sum, the disclosed techniques train and execute a machine learning model to perform multimodal conditional three-dimensional (3D) shape geometry generation, in which a 3D geometry of a face (or another type of deformable object) is generated by a machine learning model based on input conditions associated with various conditioning modes corresponding to different data modalities. For example, the machine learning model may generate the 3D geometry based on a sketch, a set of two-dimensional (2D) landmarks, a set of edges detected within an image, an image, text, and/or parameters associated with a parametric shape model. The machine learning model may include a diffusion model and/or one or more adapter models that generate a position map corresponding to the 3D geometry by iteratively denoising a noise sample based on one or more conditions associated with one or more conditioning modes.

The machine learning model is trained over multiple training stages to adapt the machine learning model to each of the conditioning modes. First, the diffusion model is trained to generate 3D geometries based on base conditions associated with a base conditioning mode (e.g., parametric shape model parameters). Next, a different adapter model is trained to inject additional conditions associated with each additional conditioning mode (e.g., sketch, landmarks, edges, image, text, etc.) into the diffusion model via cross-attention layers and/or another mechanism.

After training of the machine learning model is complete, the trained machine learning model can be used to generate new 3D geometries of deformable objects based on conditioning inputs from one or more conditioning modes and/or additional control inputs. For example, the trained machine learning model may be used to generate a position map corresponding to a 3D geometry of a deformable object based on parameters of a parametric shape model for the deformable object, an image of the deformable object, edges detected within the image, a sketch of the deformable object, 2D landmarks on the deformable object, and/or a text description of the deformable object. During generation of the 3D geometry by the trained machine learning model, the strength of a given conditioning input may be controlled using a guidance strength associated with classifier-free guidance. A mask may also be used to specify regions within a spatial layout associated with the position map to which edits pertaining to a given conditioning input or set of conditioning inputs should be made.

One technical advantage of the disclosed techniques relative to the prior art is the ability to automatically generate a 3D geometry of a deformable object from a variety of user-defined conditioning inputs. Consequently, the disclosed techniques may reduce time and resource overhead associated with generating 3D geometries, compared with traditional techniques that involve users interacting with 3D modeling tools to manually sculpt 3D geometries of deformable objects. Additionally, because the generation of the 3D geometry can be guided using multiple types of conditioning inputs and/or control inputs, the 3D geometry may more accurately reflect a desired visual and/or geometric characteristic than 3D geometries that are generated based on text prompts by conventional machine learning models. These technical advantages provide one or more technological improvements over prior art approaches.

1. In some embodiments, a computer-implemented method for generating a geometry for a shape comprises inputting, into a machine learning model, (i) a noise sample and (ii) one or more conditioning inputs; generating, via execution of the machine learning model based on the noise sample and the one or more conditioning inputs, a two-dimensional (2D) position map associated with the shape; and generating a three-dimensional (3D) geometry for the shape based on the 2D position map.

2. The computer-implemented method of clause 1, further comprising generating, via execution of the machine learning model, the 2D position map based on one or more control inputs.

3. The computer-implemented method of any of clauses 1-2, wherein the one or more control inputs comprise a guidance strength associated with the one or more conditioning inputs.

4. The computer-implemented method of any of clauses 1-3, wherein the one or more control inputs comprise a mask specifying a region of the 2D position map to be generated based on the one or more conditioning inputs.

5. The computer-implemented method of any of clauses 1-4, wherein generating the 2D position map comprises iteratively denoising the noise sample using a diffusion model included in the machine learning model based on a conditioning input that is included in the one or more conditioning inputs.

6. The computer-implemented method of any of clauses 1-5, wherein the conditioning input is processed by a set of cross-attention layers included in the diffusion model during iterative denoising of the noise sample.

7. The computer-implemented method of any of clauses 1-6, wherein the conditioning input is processed by a set of cross-attention layers included in an adapter model within the machine learning model during iterative denoising of the noise sample.

8. The computer-implemented method of any of clauses 1-7, wherein the one or more conditioning inputs comprise at least one of a set of parameters associated with a parametric shape model, a sketch, an image, a set of detected edges, a set of landmarks, or text.

9. The computer-implemented method of any of clauses 1-8, wherein generating the 3D geometry comprises combining a set of 3D displacements included in the 2D position map with a set of 3D positions included in a template mesh to produce an output mesh corresponding to the 3D geometry.

10. The computer-implemented method of any of clauses 1-9, wherein the shape comprises a deformable object.

11. In some embodiments, one or more non-transitory computer-readable media store instructions that, when executed by one or more processors, cause the one or more processors to perform the steps of inputting, into a machine learning model, (i) a noise sample and (ii) one or more conditioning inputs; generating, via execution of the machine learning model based on the noise sample and the one or more conditioning inputs, a two-dimensional (2D) position map associated with a shape; and generating a three-dimensional (3D) geometry for the shape based on the 2D position map.

12. The one or more non-transitory computer-readable media of clause 11, wherein the instructions further cause the one or more processors to perform the step of generating, via execution of the machine learning model, the 2D position map based on one or more control inputs.

13. The one or more non-transitory computer-readable media of any of clauses 11-12, wherein the one or more control inputs comprise a guidance strength associated with classifier-free guidance performed using (i) a diffusion model included in the machine learning model and (ii) the one or more conditioning inputs.

14. The one or more non-transitory computer-readable media of any of clauses 11-13, wherein the one or more control inputs comprise a mask specifying a region of the 2D position map to be generated based on the one or more conditioning inputs.

15. The one or more non-transitory computer-readable media of any of clauses 11-14, wherein generating the 2D position map comprises generating a plurality of tokens based on a conditioning input included in the one or more conditioning inputs; computing, via a set of cross-attention layers associated with a conditioning mode corresponding to the conditioning input, a conditioned representation based on the plurality of tokens and a set of features generated by a diffusion model included in the machine learning model; and denoising the noise sample based on the conditioned representation.

16. The one or more non-transitory computer-readable media of any of clauses 11-15, wherein the set of cross-attention layers is included in at least one of the diffusion model or an adapter model associated with the conditioning mode represented by the conditioning input.

17. The one or more non-transitory computer-readable media of any of clauses 11-16, wherein denoising the noise sample based on the conditioned representation comprises generating, via execution of the diffusion model, a noise prediction based on the conditioned representation and the set of features; and denoising the noise sample based on the noise prediction.

18. The one or more non-transitory computer-readable media of any of clauses 11-17, wherein generating the 2D position map comprises generating, via execution of a diffusion model included in the machine learning model, a denoised sample in a latent space based on the noise sample and the one or more conditioning inputs; and generating, via execution of a decoder neural network included in the machine learning model, the 2D position map based on the denoised sample.

19. The one or more non-transitory computer-readable media of any of clauses 11-18, wherein the shape comprises a face.

20. In some embodiments, a system comprises one or more memories that store instructions, and one or more processors that are coupled to the one or more memories and, when executing the instructions, are configured to perform the steps of inputting, into a machine learning model, (i) a noise sample and (ii) one or more conditioning inputs; generating, via execution of the machine learning model based on the noise sample and the one or more conditioning inputs, a two-dimensional (2D) position map associated with a deformable object; and generating a three-dimensional (3D) geometry for the deformable object based on the 2D position map.

21. In some embodiments, a computer-implemented method for training a machine learning model on a geometry generation task comprises generating, via execution of a diffusion model, a first set of training output corresponding to a first set of three-dimensional (3D) geometries based on a first set of conditioning inputs associated with a first conditioning mode; training the diffusion model based on a first set of loss values associated with the first set of training output; generating, via execution of the diffusion model and a first adapter model, a second set of training output corresponding to a second set of 3D geometries based on a second set of conditioning inputs associated with a second conditioning mode; and training the first adapter model based on a second set of loss values associated with the second set of training output.

22. The computer-implemented method of clause 21, further comprising generating, via execution of the diffusion model and a second adapter model, a third set of training output corresponding to a third set of 3D geometries based on a third set of conditioning inputs associated with a third conditioning mode; and training the second adapter model based on a third set of loss values associated with the third set of training output.

23. The computer-implemented method of any of clauses 21-22, further comprising generating, via execution of an encoder neural network, a set of latent representations of a set of ground truth 3D geometries associated with the first set of conditioning inputs; and computing the first set of loss values based on the set of latent representations and the first set of training output.

24. The computer-implemented method of any of clauses 21-23, further comprising generating, via execution of a decoder neural network, a third set of 3D geometries based on the set of latent representations; and training the encoder neural network and the decoder neural network based on a third set of loss values associated with the third set of 3D geometries and the set of ground truth 3D geometries.

25. The computer-implemented method of any of clauses 21-24, wherein the third set of loss values comprises at least one of a reconstruction loss, a perceptual loss, an adversarial loss, or a codebook loss.

26. The computer-implemented method of any of clauses 21-25, further comprising generating a set of ground truth 3D geometries based on augmentations of a set of scanned 3D geometries; and computing at least one of the first set of loss values or the second set of loss values based on the set of ground truth 3D geometries.

27. The computer-implemented method of any of clauses 21-26, further comprising fitting the first set of conditioning inputs to at least a portion of the set of ground truth 3D geometries.

28. The computer-implemented method of any of clauses 21-27, wherein the augmentations comprise at least one of an interpolation between two or more scanned 3D geometries or an exchange of a first portion of a first scanned 3D geometry with a second portion of a second scanned 3D geometry.

29. The computer-implemented method of any of clauses 21-28, wherein the diffusion model comprises a two-dimensional (2D) convolutional neural network.

30. The computer-implemented method of any of clauses 21-29, wherein at least one of the first set of 3D geometries and the second set of 3D geometries comprises a position map corresponding to a shape of a deformable object.

31. In some embodiments, one or more non-transitory computer-readable media store instructions that, when executed by one or more processors, cause the one or more processors to perform the steps of generating, via execution of a diffusion model, a first set of training output corresponding to a first set of three-dimensional (3D) geometries based on a first set of conditioning inputs associated with a first conditioning mode; training the diffusion model based on a first set of loss values associated with the first set of training output; generating, via execution of the diffusion model and one or more adapter models, one or more additional sets of training output corresponding to one or more additional sets of 3D geometries based on one or more additional sets of conditioning inputs associated with one or more additional conditioning modes; and training the one or more adapter models based on one or more additional sets of loss values associated with the one or more additional sets of training output.

32. The one or more non-transitory computer-readable media of clause 31, wherein the instructions further cause the one or more processors to perform the steps of generating, via execution of an encoder neural network, a set of latent representations of a set of ground truth 3D geometries associated with the one or more additional sets of conditioning inputs; and computing the one or more additional sets of loss values based on the set of latent representations and the one or more additional sets of training output.

33. The one or more non-transitory computer-readable media of any of clauses 31-32, wherein the instructions further cause the one or more processors to perform the step of generating, via execution of a trained decoder neural network, the first set of 3D geometries based on the first set of training output.

34. The one or more non-transitory computer-readable media of any of clauses 31-33, wherein the instructions further cause the one or more processors to perform the steps of generating a set of ground truth 3D geometries based on augmentations of a set of scanned 3D geometries; and computing at least one of the first set of loss values or the one or more additional sets of loss values based on the set of ground truth 3D geometries.

35. The one or more non-transitory computer-readable media of any of clauses 31-34, wherein the set of ground truth 3D geometries comprises the set of scanned geometries and an additional set of 3D geometries generated using the augmentations of the set of scanned 3D geometries.

36. The one or more non-transitory computer-readable media of any of clauses 31-35, wherein the instructions further cause the one or more processors to perform the step of generating the one or more additional sets of conditioning inputs based on additional data associated with the set of scanned 3D geometries.

37. The one or more non-transitory computer-readable media of any of clauses 31-36, wherein at least one of the first set of loss values or the one or more additional sets of loss values is computed based on a predicted noise generated by the diffusion model.

38. The one or more non-transitory computer-readable media of any of clauses 31-37, wherein the first set of conditioning inputs comprises a set of parameters associated with a parametric shape model and the one or more additional sets of conditioning inputs comprise at least one of a sketch, an image, a set of detected edges, a set of landmarks, or text.

39. The one or more non-transitory computer-readable media of any of clauses 31-38, wherein the one or more adapter models comprise at least one of an embedding model, a projection network, or a set of cross-attention layers.

40. In some embodiments, a system comprises one or more memories that store instructions, and one or more processors that are coupled to the one or more memories and, when executing the instructions, are configured to perform the steps of generating, via execution of a diffusion model, a first set of training output corresponding to a first set of three-dimensional (3D) geometries for a deformable object based on a first set of conditioning inputs associated with a first conditioning mode; training the diffusion model based on a first set of loss values associated with the first set of training output; generating, via execution of the diffusion model and a first adapter model, a second set of training output corresponding to a second set of 3D geometries for the deformable object based on a second set of conditioning inputs associated with a second conditioning mode; and training the first adapter model based on a second set of loss values associated with the second set of training output.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model on a geometry generation task, the method comprising:
generating, via execution of a diffusion model, a first set of training output corresponding to a first set of three-dimensional (3D) geometries based on a first set of conditioning inputs associated with a first conditioning mode;
training the diffusion model based on a first set of loss values associated with the first set of training output;
generating, via execution of the diffusion model and a first adapter model, a second set of training output corresponding to a second set of 3D geometries based on a second set of conditioning inputs associated with a second conditioning mode; and
training the first adapter model based on a second set of loss values associated with the second set of training output.

2. The computer-implemented method of claim 1, further comprising:
generating, via execution of the diffusion model and a second adapter model, a third set of training output corresponding to a third set of 3D geometries based on a third set of conditioning inputs associated with a third conditioning mode; and
training the second adapter model based on a third set of loss values associated with the third set of training output.

3. The computer-implemented method of claim 1, further comprising:
generating, via execution of an encoder neural network, a set of latent representations of a set of ground truth 3D geometries associated with the first set of conditioning inputs; and
computing the first set of loss values based on the set of latent representations and the first set of training output.

4. The computer-implemented method of claim 3, further comprising:
generating, via execution of a decoder neural network, a third set of 3D geometries based on the set of latent representations; and
training the encoder neural network and the decoder neural network based on a third set of loss values associated with the third set of 3D geometries and the set of ground truth 3D geometries.

5. The computer-implemented method of claim 4, wherein the third set of loss values comprises at least one of a reconstruction loss, a perceptual loss, an adversarial loss, or a codebook loss.

6. The computer-implemented method of claim 1, further comprising:
generating a set of ground truth 3D geometries based on augmentations of a set of scanned 3D geometries; and
computing at least one of the first set of loss values or the second set of loss values based on the set of ground truth 3D geometries.

7. The computer-implemented method of claim 6, further comprising fitting the first set of conditioning inputs to at least a portion of the set of ground truth 3D geometries.

8. The computer-implemented method of claim 6, wherein the augmentations comprise at least one of an interpolation between two or more scanned 3D geometries or an exchange of a first portion of a first scanned 3D geometry with a second portion of a second scanned 3D geometry.

9. The computer-implemented method of claim 1, wherein the diffusion model comprises a two-dimensional (2D) convolutional neural network.

10. The computer-implemented method of claim 1, wherein at least one of the first set of 3D geometries and the second set of 3D geometries comprises a position map corresponding to a shape of a deformable object.

11. One or more non-transitory computer-readable media storing instructions that, when executed by one or more processors, cause the one or more processors to perform the steps of:
generating, via execution of a diffusion model, a first set of training output corresponding to a first set of three-dimensional (3D) geometries based on a first set of conditioning inputs associated with a first conditioning mode;
training the diffusion model based on a first set of loss values associated with the first set of training output;
generating, via execution of the diffusion model and one or more adapter models, one or more additional sets of training output corresponding to one or more additional sets of 3D geometries based on one or more additional sets of conditioning inputs associated with one or more additional conditioning modes; and
training the one or more adapter models based on one or more additional sets of loss values associated with the one or more additional sets of training output.

12. The one or more non-transitory computer-readable media of claim 11, wherein the instructions further cause the one or more processors to perform the steps of:
generating, via execution of an encoder neural network, a set of latent representations of a set of ground truth 3D geometries associated with the one or more additional sets of conditioning inputs; and
computing the one or more additional sets of loss values based on the set of latent representations and the one or more additional sets of training output.

13. The one or more non-transitory computer-readable media of claim 11, wherein the instructions further cause the one or more processors to perform the step of generating, via execution of a trained decoder neural network, the first set of 3D geometries based on the first set of training output.

14. The one or more non-transitory computer-readable media of claim 11, wherein the instructions further cause the one or more processors to perform the steps of:
generating a set of ground truth 3D geometries based on augmentations of a set of scanned 3D geometries; and
computing at least one of the first set of loss values or the one or more additional sets of loss values based on the set of ground truth 3D geometries.

15. The one or more non-transitory computer-readable media of claim 14, wherein the set of ground truth 3D geometries comprises the set of scanned geometries and an additional set of 3D geometries generated using the augmentations of the set of scanned 3D geometries.

16. The one or more non-transitory computer-readable media of claim 14, wherein the instructions further cause the one or more processors to perform the step of generating the one or more additional sets of conditioning inputs based on additional data associated with the set of scanned 3D geometries.

17. The one or more non-transitory computer-readable media of claim 11, wherein at least one of the first set of loss values or the one or more additional sets of loss values is computed based on a predicted noise generated by the diffusion model.

18. The one or more non-transitory computer-readable media of claim 11, wherein the first set of conditioning inputs comprises a set of parameters associated with a parametric shape model and the one or more additional sets of conditioning inputs comprise at least one of a sketch, an image, a set of detected edges, a set of landmarks, or text.

19. The one or more non-transitory computer-readable media of claim 11, wherein the one or more adapter models comprise at least one of an embedding model, a projection network, or a set of cross-attention layers.

20. A system, comprising:
one or more memories that store instructions, and
one or more processors that are coupled to the one or more memories and, when executing the instructions, are configured to perform the steps of:
generating, via execution of a diffusion model, a first set of training output corresponding to a first set of three-dimensional (3D) geometries for a deformable object based on a first set of conditioning inputs associated with a first conditioning mode;
training the diffusion model based on a first set of loss values associated with the first set of training output;
generating, via execution of the diffusion model and a first adapter model, a second set of training output corresponding to a second set of 3D geometries for the deformable object based on a second set of conditioning inputs associated with a second conditioning mode; and
training the first adapter model based on a second set of loss values associated with the second set of training output.
